(19) United States
(12) Patent Application Publication
(10) Pub. No.: US 2007/0139969 A1
(43) Pub. Date: Jun. 21, 2007

(54) Bulb assembly with dual secure functions

(76) Inventor: Hung-Huei Cheng, Taipei City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/304,559

(22) Filed: Dec. 16, 2005

(51) Int. Cl. H01R 33/00

(52) U.S. Cl. 362/653

(57) ABSTRACT

The invention relates to an improved bulb assembly with dual functions, which includes a holder having two receiving holes for connecting with a bulb and a fuse apparatus that provides a dual secure effect. As in use, it provides a stable lighting effect. When any bulb is broken, the light string can keep work as normal since the bulb assembly makes sure of electrical connection therebetween by fuse apparatus.

### FIELD OF THE INVENTION

The present invention relates to an improvement of a bulb assembly, which includes a holder with two receiving holes for connecting with a bulb and a fuse apparatus respectively that obtains dual secure functions.

### BACKGROUND OF THE INVENTION

It is known that a light string includes a main electric wire to connect with many bulb assemblies, wherein each bulb assembly is serial connected with each other in the light string. Hence, if any one of the bulb assemblies is broken, the light string will be out of work. In order to solve this problem, it is known that a second circuit is always provided in the bulb. If the tungsten filament is burned out, the second circuit becomes a bridge of electric current in the bulb to keep the light string in normal. The effect is still poor because the second circuit is also easy to be burned out. The light string is then useless.

### SUMMARY OF THE INVENTION

The present invention is to provide an improved bulb assembly, which includes a holder having two receiving holes for connecting with the bulb and a fuse apparatus that provides a dual secure effect. Now, accompanying with the following drawings, the character of the present invention will be described here and after.

### BRIEF DESCRIPTION OF THE DRAWINGS

FIG. 1 is an exploded perspective view showing a bulb assembly according to the present invention.

FIG. 2 is an assembled view of FIG. 1.

FIG. 3 is an exploded perspective view showing a modified bulb assembly according to the present invention.

FIG. 4 is an exploded perspective view showing a modified bulb assembly of FIG. 1 connecting with another fuse apparatus.

FIG. 5 is an exploded perspective view showing another embodiment of a bulb assembly according to the present invention.

FIG. 6 is an assembled view of FIG. 5.

### DETAILED DESCRIPTION OF THE PREFERRED EMBODIMENT

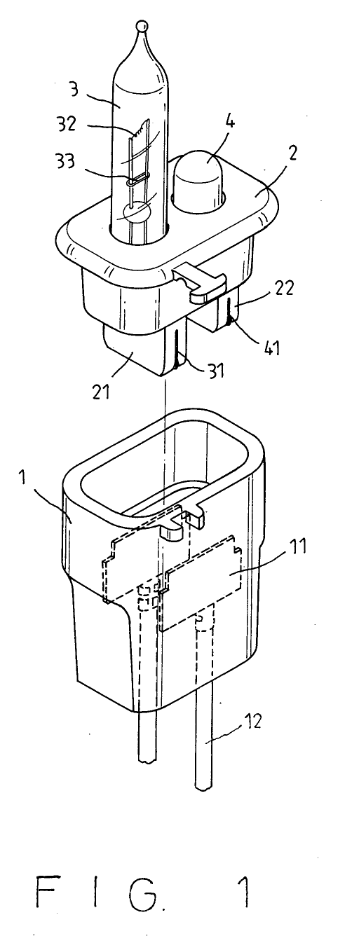

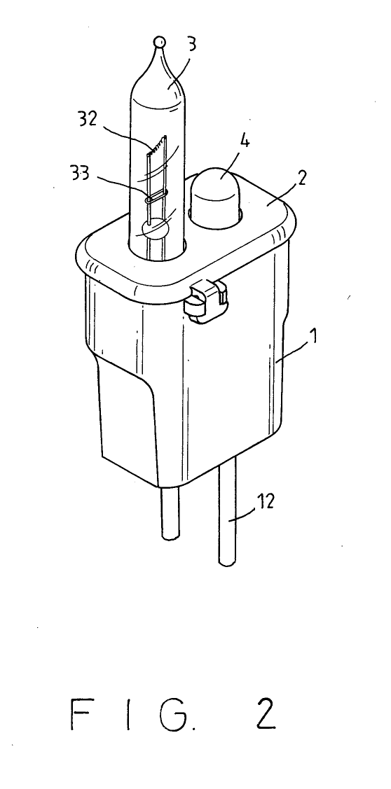

Please refer to FIGS. 1 and 2, the present invention relates to an improvement of a bulb assembly, which includes a shell (1) having two conductive slices (11) connected with electric wires (12) extending outward. The shell (1) has an opening for receiving a holder (2) with a similar configuration, which includes two receiving holes to connect with a bulb (3) and a fuse apparatus (4) respectively. The holder (2) also includes a long leg (21) and a short leg (22), wherein the bulb (3) has its two conductive wires (31) be folded beside the long leg (21) and the fuse apparatus (4) has its two conductive wires (41) beside the short leg (22). When the holder (2) is inserting into the shell (1), the conductive wires (31) of the bulb (3) is going to contact the conductive slice (11) before the fuse apparatus (4) does that can make sure of the bulb (3) to work normally.

In use, every bulb (3) in the light string can emit light for decorative purpose. As the tungsten filament (32) and the second circuit (33) in the bulb (3) are both broken at the same time, the fuse apparatus (4) becomes an electric connecting bridge for the related bulb assembly. Hence, the light string remains a perfect electric circuit and other bulb assemblies work and emit light as normal that obtains a dual secure purpose. It is to be understood that a fuse apparatus with high resistance parallelly connected with the bulb provides a perfect protecting effect for a light string.

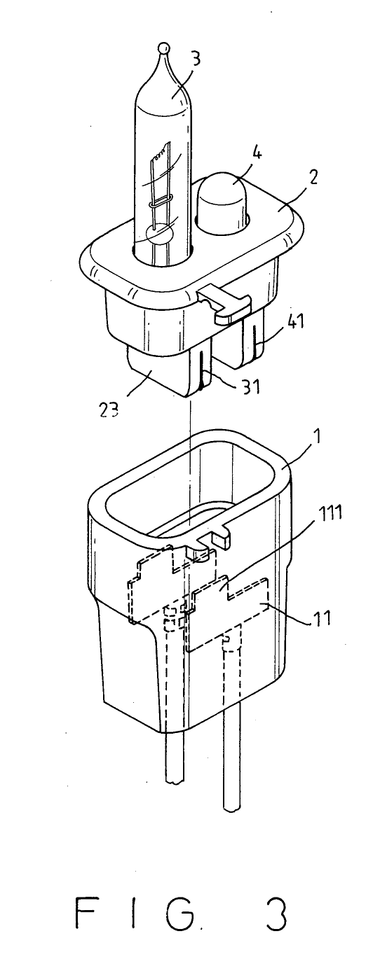

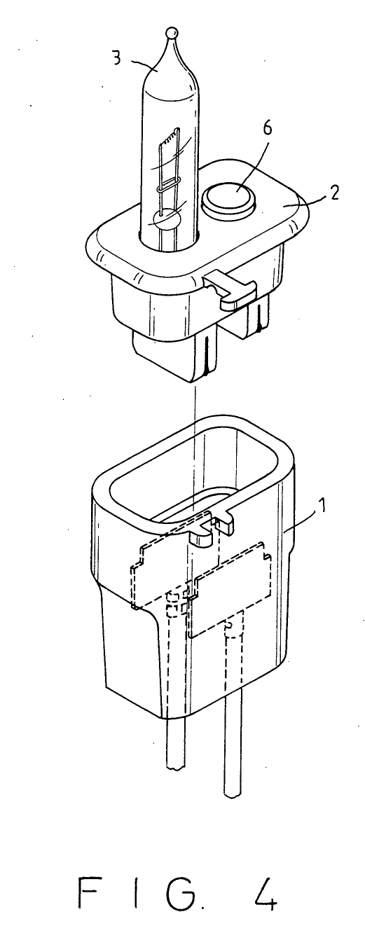

By above invented spirit, the present invention includes a modified application, such as in FIG. 3, wherein the holder (2) has equal legs (23) while the conductive slice (11) in the shell (1) has a projecting portion (111) relating to the bulb (3). This structure makes sure that the conductive wire (31) of the bulb (3) contacts with the slice (11) before the conductive wire (41) of the fuse apparatus when to insert the holder (2) into the shell (1). Referring to FIG. 4, it shows another embodiment that a modified fuse apparatus (6) is applied to obtain a same effect.

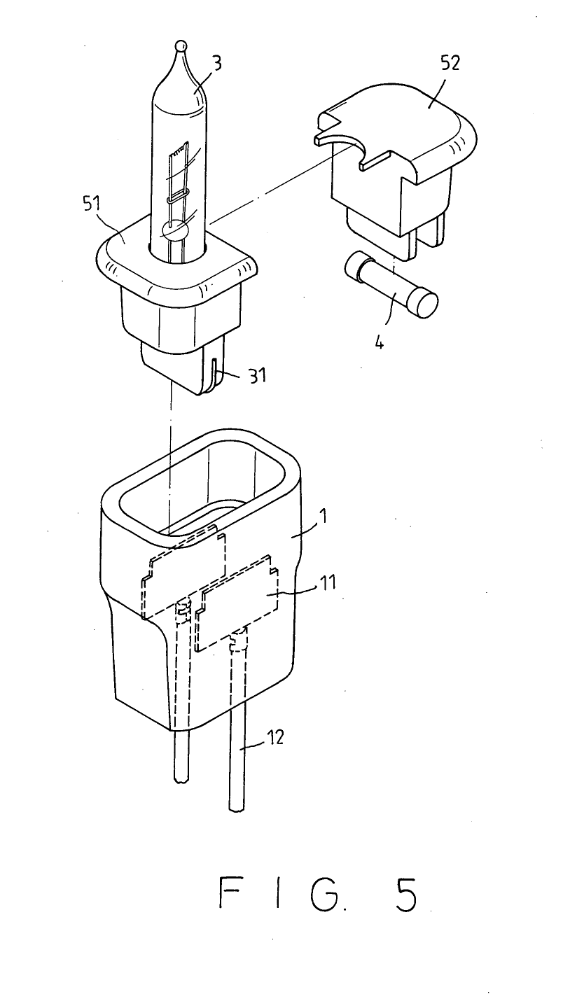

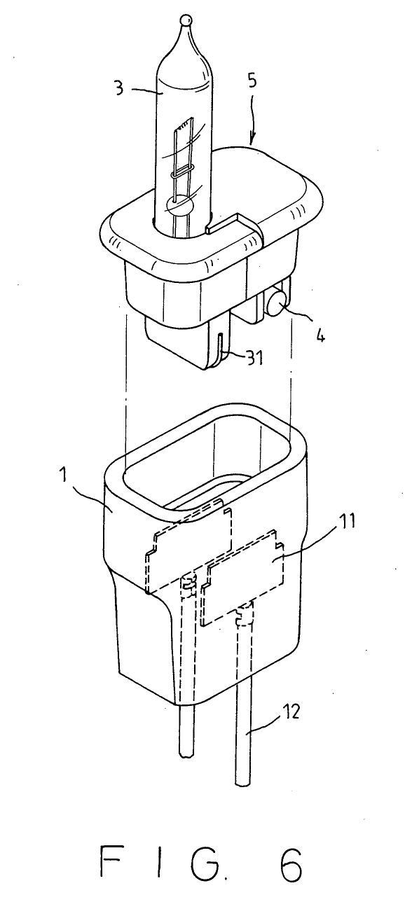

As shown in FIGS. 5 and 6, it is still another modified embodiment, which includes an assembled holder (5) comprised of a bulb receiver (51) and a connector (52) to be inserted into the shell (1), wherein the fuse apparatus (4) can be a conventional fuse connected under the connector (52) at a position higher than the conductive wires (31) of the bulb (3) that reaches the same dual secure effect. Accordingly, the present invention should be allowed for patent based on its improvement.

I claim:

1. A bulb assembly with dual functions including a shell with two conductive slices connected with electric wires extending outward having an opening for receiving a holder, which includes two receiving holes to connect with a bulb and a fuse apparatus respectively; the holder including a long leg and a short leg, wherein the bulb has its two conductive wires be folded beside the long leg and the fuse apparatus has its two conductive wires beside the short leg to contact with the conductive slices respectively for dual secure effects.

2. The bulb assembly with dual functions as claimed in claim 1, wherein the holder has equal legs while conductive slices have a projecting portion relating to the conductive wires of the bulb.

3. The bulb assembly with dual functions as claimed in claim 1, wherein the holder is comprised of a bulb receiver and a connector, which connects with a fuse apparatus at bottom.
